(19) United States
(12) Patent Application Publication
(10) Pub. No.: US 2013/0076868 A1
(43) Pub. Date: Mar. 28, 2013

(54) STEREOSCOPIC IMAGING APPARATUS, FACE DETECTION APPARATUS AND METHODS OF CONTROLLING OPERATION OF SAME

(71) Applicant: Fujifilm Corporation, Tokyo (JP)

(72) Inventor: Masato FUJII, Saitama-shi (JP)

(73) Assignee: FUJIFILM CORPORATION, Tokyo (JP)

(21) Appl. No.: 13/683,832

(22) Filed: Nov. 21, 2012

Related U.S. Application Data
(63) Continuation of application No. PCT/JP2011/059889, filed on Apr. 15, 2011.

(30) Foreign Application Priority Data
May 24, 2010 (JP) 2010-117890

(51) Int. Cl. H04N 13/02

(52) U.S. Cl. CPC H04N 13/0203
USPC 348/47

(57) ABSTRACT

A face image is specified and face image detection is performed in a left-eye image and in a right-eye image. If a face image is detected in only one of these images, then object image detection is performed in the left-eye image and in the right-eye image. The distance to an object represented by an object image contained in one image and the distance to an object represented by an object image contained in the other image are calculated. From among objects represented by object images contained in the other image, the image of an object having a distance equal to the distance to the face represented by the face image detected in the one image is specified as a face image.

### TECHNICAL FIELD

This invention relates to a stereoscopic imaging apparatus, a face detection apparatus and methods of controlling the operation thereof.

### BACKGROUND ART

In an apparatus for capturing a stereoscopic image, a left-eye image and a right-eye image are captured and each image is controlled so as to be brought into focus. With an arrangement (Japanese Patent Application Laid-Open No. 2007-110500) in which control is exercised so as to achieve focusing of only one of the images, the other image will not necessarily be brought into focus. Although there is an arrangement (Japanese Patent Application Laid-Open No. 2010-28219) in which focusing is controlled by recognizing different subjects in left- and right-eye images, no consideration is given to a case where a subject is detected in only one image. Further, although there is an arrangement (Japanese Patent Application Laid-Open No. 2008-108243) in which a face is detected from an image captured by a first camera and a face is detected from an image captured by a second camera, detection accuracy is not very high. Thus, it is difficult to detect a face accurately in both the left- and right-eye images that constitute a stereoscopic image.

### DISCLOSURE OF THE INVENTION

An object of the present invention is to detect a face image accurately from both left- and right-eye images that constitute a stereoscopic image.

A stereoscopic imaging apparatus according to a first aspect of the present invention is characterized by comprising: a left-eye image capture device for capturing a left-eye image constituting a stereoscopic image; a right-eye image capture device for capturing a right-eye image constituting the stereoscopic image; a face image detection device (face image detection means) for detecting face images in respective ones of the left-eye image captured in the left-eye image capture device and right-eye image captured in the right-eye image capture device; an object image detection device (object image detection means) for detecting, in accordance with detection of a face image from only one image of the left- and right-eye images in the face image detection device, object images contained in the other image of the left- and right-eye images in which a face image was not detected by the face image detection device; a first distance calculation device (first distance calculation means) for calculating distance from the stereoscopic imaging apparatus to the face represented by the face image detected by the face image detection device; and a face image decision device (face image decision means) for deciding that, from among the object images detected by the object image detection device, an object image representing an object having the distance calculated by the first distance calculation device is a face image in the other image.

The first aspect of the present invention also provides a method of controlling the operation of the above-described stereoscopic imaging apparatus. Specifically, the method comprises: a left-eye image capture device capturing a left-eye image constituting a stereoscopic image; a right-eye image capture device capturing a right-eye image constituting the stereoscopic image; a face image detection device detecting face images in respective ones of the left-eye image captured in the left-eye image capture device and right-eye image captured in the right-eye image capture device; an object image detection device detecting, in accordance with detection of a face image from only one image of the left- and right-eye images in the face image detection device, object images contained in the other image of the left- and right-eye images in which a face image was not detected by the face image detection device; a distance calculation device calculating distance from the stereoscopic imaging apparatus to the face represented by the face image detected by the face image detection device; and a face image decision device deciding that, from among the object images detected by the object image detecting device, an object image representing an object having the distance calculated by the first distance calculation device is a face image in the other image.

In accordance with the first aspect of the present invention, detection of a face image is performed in each of left- and right-eye images. If a face image is detected from only one of the images, object images, which are the images of objects contained in the other image in which a face image was not detected, are detected. Further, the distance to the face represented by the detected face image is calculated. From among object images represented by the objects detected from the other image, an object image represented by an object whose distance is the same as the distance to the detected face is decided upon as a face image. Thus, in a case where a face image cannot be detected from the other image, the face image can be found comparatively accurately.

The apparatus further comprises: a left-eye focusing lens provided in front of a solid-state electronic image sensing device, which is included in the left-eye image capture device, and freely movable along the direction of an optic axis of the left-eye image capture device; a right-eye focusing lens provided in front of a solid-state electronic image sensing device, which is included in the right-eye image capture device, and freely movable along the direction of an optic axis of the right-eye image capture device; a second distance calculation device (second distance calculation means) for calculating distance from the stereoscopic imaging apparatus to the face represented by the face image decided by the face image decision device; and a focus control device (focus control means) for deciding directions of movement of respective ones of the left-eye focusing lens and right-eye focusing lens based upon the distance calculated by the second distance calculation device and positions of respective ones of the left-eye focusing lens and right-eye focusing lens, and controlling focusing while moving the left-eye focusing lens and right-eye focusing lens along the directions decided.

A stereoscopic imaging apparatus according to a second aspect of the present invention is characterized by comprising: a left-eye image capture device for capturing a left-eye image constituting a stereoscopic image; a right-eye image capture device for capturing a right-eye image constituting the stereoscopic image; a face image detection device (face image detection means) for detecting face images in respective ones of the left-eye image captured in the left-eye image capture device and right-eye image captured in the right-eye image capture device; an object image detection device (object image detection means) for detecting, in accordance with detection of a face image from only one image of the left- and right-eye images in the face image detection device, object images contained in images in respective ones of the left- and right-eye images; a first distance calculation device (first distance calculation means) for calculating distance from the stereoscopic imaging apparatus to the face represented by the face image detected by the face image detection device; a first face image candidate region decision device (first face image candidate region decision means) for deciding that, from among the object images, which were detected by the object image detection device, contained in the other image of the left- and right-eye images in which a face image was not detected by the face image detection device, an object image representing an object having the distance calculated by the first distance calculation device is a first face image candidate region in the other image; a distance calculation device (distance calculation means) for calculating, in the one image, distances from one object image among the object images detected by the object image detection device to at least two points that specify the face image; a second face image candidate region decision device (second face image candidate region decision means) for deciding that, in the other image, an object represented by an object image at the distances, calculated by the distance calculation device, from another object image, which corresponds to the one object image from among the object images detected by the object image detection device, to the at least two points is a second face image candidate region in the other image based upon coincidence with an object represented by an object image at the distances from the one object image to the at least two points; and a face image decision device (face image decision means) for deciding that a region common to both the first face image candidate region decided by the first face image candidate decision device and the second face image candidate region decided by the second face image candidate decision device is a region of a face image in the other image.

The second aspect of the present invention also provides a method of controlling the operation of the above-described stereoscopic imaging apparatus. Specifically, the method comprises: a left-eye image capture device capturing a left-eye image constituting a stereoscopic image; a right-eye image capture device capturing a right-eye image constituting the stereoscopic image; a face image detection device detecting face images in respective ones of the left-eye image captured in the left-eye image capture device and right-eye image captured in the right-eye image capture device; an object image detection device detecting, in accordance with detection of a face image from only one image of the left- and right-eye images in the face image detection device, object images contained in respective ones of the left- and right-eye images; a first distance calculation device for calculating distance from the stereoscopic imaging apparatus to the face represented by the face image detected by the face image detection device; a first face image candidate region decision device deciding that, from among the object images, which were detected by the object image detection device, contained in the other image of the left- and right-eye images in which a face image was not detected by the face image detection device, an object image representing an object having the distance calculated by the first distance calculation device is a first face image candidate region in the other image; a second distance calculation device calculating, in the one image, distances from one object image among the object images detected by the object image detection device to at least two points that specify the face image; a second face image candidate region decision device deciding that, in the other image, an object represented by an object image at the distances, calculated by the distance calculation device, from another object image, which corresponds to the one object image from among the object images detected by the object image detection device, to the at least two points is a second face image candidate region of the other image based upon coincidence with an object represented by an object image at the distances from the one object image to the at least two points; and a face image decision device deciding that a region common to both the first face image candidate region decided by the first face mage candidate decision device and the second face image candidate region decided by the second face image candidate decision device is a region of a face image in the other image.

In accordance with the second aspect of the present invention, the region of a face image decided as in the first aspect of the present invention is decided upon as a first face image candidate region. Further, in the one image in which a face image was detected, the distances from one object image among detected object images to at least two points specifying the face image are calculated. In the other image in which the face image was not detected, an object represented by an object image at the calculated distances from another object image, which corresponds to the one object image among the detected object images, to the at least two points is decided upon as a second face image candidate region in the other image based upon coincidence with an object represented by an object image at the distances from the one object image to the at least two points. A region common to both the first face image candidate region and the second face image candidate region is decided upon as the region of a face image in the other image.

In accordance with the second aspect of the present invention, even in a case where a face image is not detected, the distance from one object image in one image, in which a face image has been detected, to the face image is utilized to decide a second face image candidate region which will be a candidate for a face image in the other image. Since a region common to both the first face image candidate region and second face image candidate region that have been decided is decided upon as a face image region, the region of the face image can be decided comparatively accurately.

The apparatus further comprises: a left-eye focusing lens provided in front of the left-eye image capture device and freely movable along the direction of an optic axis of the left-eye image capture device; a right-eye focusing lens provided in front of the right-eye image capture device and freely movable along the direction of an optic axis of the right-eye image capture device; a second distance calculation device (second distance calculation means) for calculating distance from the stereoscopic imaging apparatus to the face represented by the face image decided by the face image decision device; and a focus control device (focus control means) for deciding directions of movement of respective ones of the left-eye focusing lens and right-eye focusing lens based upon the distance calculated by the second distance calculation device and positions of respective ones of the left-eye focusing lens and right-eye focusing lens, and controlling focusing while moving the left-eye focusing lens and right-eye focusing lens along the directions decided.

A face detection apparatus according to a third aspect of the present invention comprises: a face image detection device (face image detection means) for detecting face images in respective ones of a left-eye image and a right-eye image constituting a stereoscopic image; an object image detection device (object image detection means) for detecting, in accordance with detection of a face image from only one image of the left- and right-eye images in the face image detection device, object images contained in respective ones of the left- and right-eye images; a distance calculation device (distance calculation means) for calculating, in the one image, distances from one object image among the object images detected by the object image detection device to at least two points specifying the face image; and a face image decision device (face image decision means) for deciding that, in the other image, an object represented by an object image at the distances, calculated by the distance calculation device, from another object image, which corresponds to the one object image from among the object images detected by the object image detection device, to the at least two points is a face image in the other image based upon coincidence with an object represented by an object image at the distances from the one object image to the at least two points.

The third aspect of the present invention also provides a method of controlling the operation of the above-described face detection apparatus. Specifically, the method comprises: a face image detection device detecting face images in respective ones of a left-eye image and a right-eye image constituting a stereoscopic image; an object image detection device detecting, in accordance with detection of a face image from only one image of the left- and right-eye images in the face image detection device, object images contained in images in respective ones of the left- and right-eye images; a distance calculation device calculating, in the one image, distances from one object image among the object images detected by the object image detection device to at least two points specifying the face image; and a face image decision device deciding that, in the other image, an object represented by an object image at the distances, calculated by the distance calculation device, from another object image, which corresponds to the one object image from among the object images detected by the object image detection device, to the at least two points is a face image in the other image based upon coincidence with an object represented by an object image at the distances from the one object image to the at least two points.

In accordance with the third aspect of the present invention, in a manner similar to that of the second aspect of the present invention described above, in the one image in which a face image was detected, the distances from one object image among detected object images to at least two points specifying the face image are calculated. In the other image in which the face image was not detected, an object represented by an object image at the calculated distances from another object image, which corresponds to the one object image among the detected object images, to the at least two points is decided upon as a face image in the other image based upon coincidence with an object represented by an object image at the distances from the one object image to the at least two points.

By way of example, the face image decision device decides that, in the other image, an object image in the vicinity of the distances from the one object image to the at least two points is a face image in the other image based upon non-coincidence of an object, which is represented by an object image at the distances, calculated by the distance calculation device, from another object image, which corresponds to the one object image from among the object images detected by the object image detection device, to the at least two points, with an object represented by an object image at the distances from the one object image to the at least two points.

The apparatus may further comprise: a left-eye image capture device for capturing a left-eye image constituting a stereoscopic image, and a right-eye image capture device for capturing a right-eye image constituting the stereoscopic image. In this case, the face image detection device would detect face images in respective ones of the left- and right-eye images captured by respective ones of the left- and right-eye image capture devices. The apparatus further comprises: a left-eye focusing lens provided in front of the left-eye image capture device and freely movable along the direction of an optic axis of the left-eye image capture device; a right-eye focusing lens provided in front of the right-eye image capture device and freely movable along the direction of an optic axis of the right-eye image capture device; a second distance calculation device (second distance calculation means) for calculating distance from the face detection apparatus to the face represented by the face image decided by the face image decision device; and a focus control device (focus control means) for deciding directions of movement of respective ones of the left-eye focusing lens and right-eye focusing lens based upon the distance calculated by the second distance calculation device and positions of respective ones of the left-eye focusing lens and right-eye focusing lens, and controlling focusing while moving the left-eye focusing lens and right-eye focusing lens along the directions decided.

### BRIEF DESCRIPTION OF THE DRAWINGS

FIG. 1 is a block diagram illustrating the electrical configuration of a stereoscopic imaging digital camera;

FIG. 2a illustrates an example of a left-eye image and FIG. 2b illustrates an example of a right-eye image;

FIG. 3 is a flowchart illustrating a portion of a processing procedure of the stereoscopic imaging digital camera;

FIG. 4 is a flowchart illustrating a portion of a processing procedure of the stereoscopic imaging digital camera;

FIG. 5 is an example of a left-eye image that has been divided into regions;

FIG. 6 is an example of an object image of the left-eye image;

FIG. 7a illustrates an example of an object image of the left-eye image and FIG. 7b an example of an object image of the right-eye image;

FIG. 8a illustrates an example of an object image of the left-eye image and FIG. 8b an example of an object image of the right-eye image;

FIG. 9 is an example of an object image of the right-eye image;

FIG. 10 illustrates focus lens positions;

FIG. 11 illustrates the relationship between the stereoscopic imaging digital camera and a face;

FIG. 12 is a flowchart illustrating a portion of a processing procedure of the stereoscopic imaging digital camera;

FIG. 13a illustrates an example of an object image of the left-eye image and FIG. 13b an example of an object image of the right-eye image;

FIG. 14 is an example of an object image of the right-eye image;

FIG. 15 is an example of an object image of the right-eye image;

FIG. 16 is a flowchart illustrating a portion of a processing procedure of the stereoscopic imaging digital camera;

FIG. 17 is a flowchart illustrating a portion of a processing procedure of the stereoscopic imaging digital camera; and

FIG. 18 is an example of an object image of the right-eye image.

### BEST MODE FOR CARRYING OUT THE INVENTION

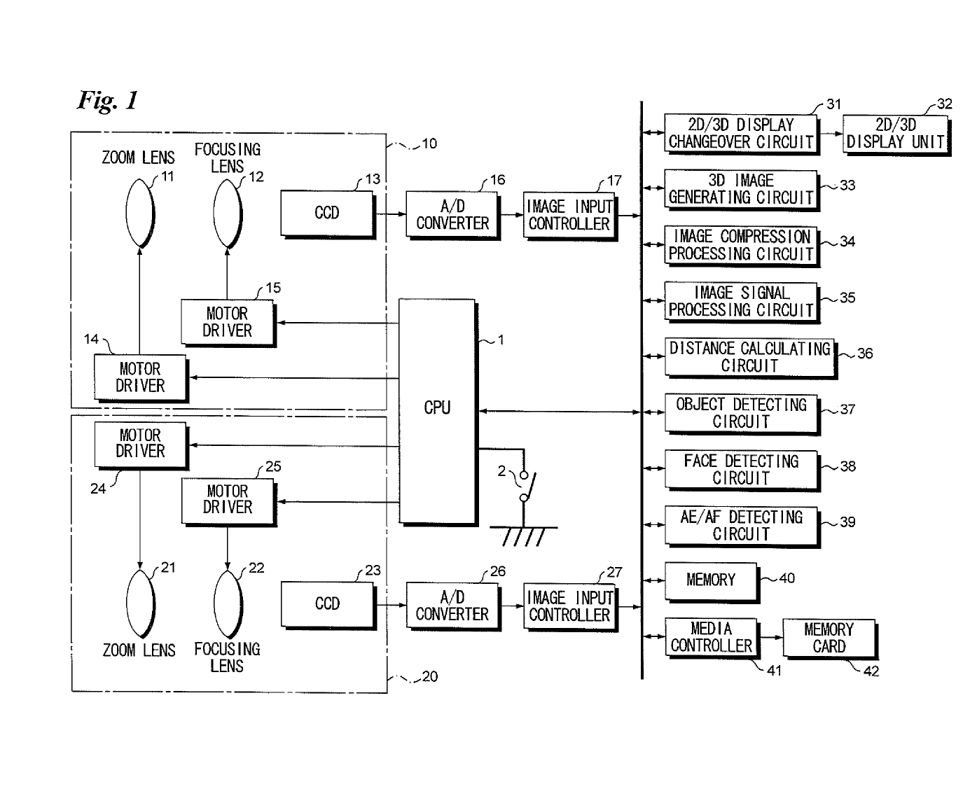

FIG. 1 is a block diagram illustrating the electrical configuration of a stereoscopic imaging digital camera.

The overall operation of the stereoscopic imaging digital camera is controlled by a CPU 1. The stereoscopic imaging digital camera is provided with a shutter-release button 2. A signal indicating depression of the shutter-release button 2 is input to the CPU 1. The stereoscopic imaging digital camera also includes a memory 40 for storing prescribed data.

The stereoscopic imaging digital camera includes a left-eye image capture device 10 and a right-eye image capture device 20 that have a substantially common imaging zone. A subject is imaged by the left-eye image capture device 10 and right-eye image capture device 20.

The left-eye image capture device 10 images the subject, thereby outputting image data representing a left-eye image that constitutes a stereoscopic image. The left-eye image capture device 10 includes a first CCD 13. A zoom lens 11 and a focusing lens 12 are provided in front of the first CCD 13. The zoom lens 11 and focusing lens 12 are positioned by motor drivers 14 and 15. When an imaging mode is established and a left-eye image is formed on the photoreceptor surface of the first CCD 13, a left-eye video signal representing the left-eye image is output from the first CCD 13.

The left-eye image video signal that has been output from the first CCD 13 is converted to digital left-eye image data in an analog/digital converting unit 16. The left-eye image data is input to an image signal processing circuit 35 from an image input controller 17. The image signal processing circuit 35 applies the left-eye image data to prescribed signal processing. The left-eye image data that has been output from the image signal processing circuit 35 is input an AE/AF detecting circuit 39. Based upon the left-eye image data input thereto, the AE/AF detecting circuit 39 calculates the amount of exposure of the left-eye image capture device 10 and an AF evaluation value for deciding the in-focus position of the focusing lens 12. The shutter speed (electronic shutter) is decided based upon the exposure value calculated. The lens position of the focusing lens 12 is decided based upon the AF evaluation value calculated.

The right-eye image capture device 20 images the subject, thereby outputting image data representing a right-eye image that constitutes a stereoscopic image. The right-eye image capture device 20 includes a second CCD 23. A zoom lens 21 and a focusing lens 22 are provided in front of the second CCD 23. The zoom lens 21 and focusing lens 22 are positioned by motor drivers 24 and 25. When an imaging mode is established and a right-eye image is formed on the photoreceptor surface of the second CCD 23, a right-eye video signal representing the right-eye image is output from the second CCD 23.

The right-eye image video signal that has been output from the second CCD 23 is converted to digital right-eye image data in an analog/digital converting unit 26. The right-eye image data is input to the image signal processing circuit 35 from an image input controller 27. The right-eye image data is subjected to prescribed signal processing by the image signal processing circuit 35 in a manner similar to that of the left-eye image data. The right-eye image data that has been output from the image signal processing circuit 35 is input an AE/AF detecting circuit 39. Based upon the right-eye image data input thereto, the AE/AF detecting circuit 39 calculates the amount of exposure of the right-eye image capture device 20 and an AF evaluation value for deciding the in-focus position of the focusing lens 22. The shutter speed (electronic shutter) is decided based upon the exposure value calculated. The lens position of the focusing lens 22 is decided based upon the EF evaluation value calculated.

The items of left-eye image data and right-eye image data obtained as set forth above are also input to a face detecting circuit 38. The face detecting circuit 38 detects face images from respective ones of the images of the left- and right-eye images.

In a case where a stereoscopic image is displayed on a 2D/3D display unit 32, the 2D/3D display unit 32 is changed over to a 3D display by a 2D/3D display changeover circuit 31. In the case of the stereoscopic image display, the items of the left-eye image data and right-eye image data are input to a 3D image generating circuit 33 so that image data representing a stereoscopic image in which an image is displayed in stereoscopic fashion is generated. The image data representing the generated stereoscopic image is applied to the 2D/3D display unit 32 via the 2D/3D display changeover circuit 31, whereby a stereoscopic image is displayed.

In a case where a planar image is displayed on the 2D/3D display unit 32, the 2D/3D display unit 32 is changed over to a 2D display by the 2D/3D display changeover circuit 31. In the case of the planar image display, the image data of either the left-eye image data or right-eye image data is applied to the 2D/3D display unit 32 via the 2D/3D display changeover circuit 31. A planar image is displayed on the display screen of the 2D/3D display unit 32.

When the shutter-release button 2 is pressed, the items of left-eye image data and right-eye image data obtained in the manner set forth above are recorded on a memory card 42 under the control of a media controller 41.

Furthermore, the stereoscopic imaging digital camera according to this embodiment can detect not only face images but also the images of prescribed objects (sky, water, trees, earth and buildings, etc.) from within an image. In order to detect the image of an object, the stereoscopic imaging digital camera is provided with an object detecting circuit 37. The stereoscopic imaging digital camera is further provided with a distance calculating circuit 36 for calculating the distance from the image of an object detected within an image to a face image.

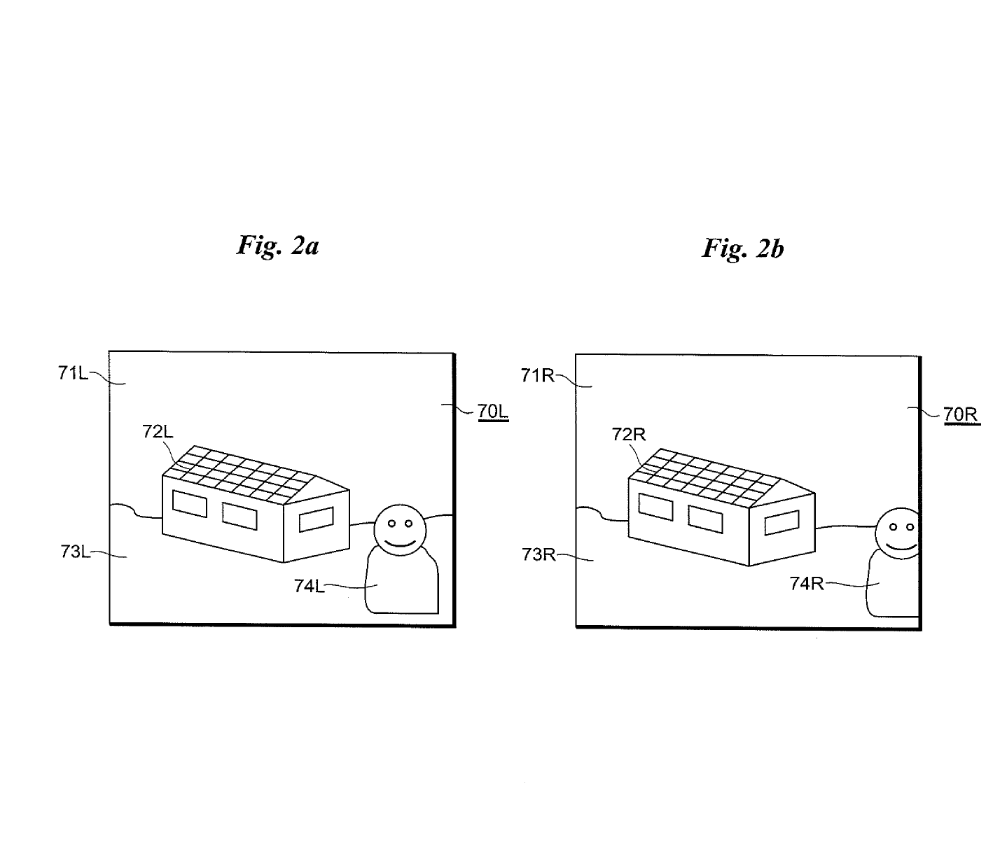

FIG. 2a is an example of a left-eye image and FIG. 2b an example of a right-eye image.

A left-eye image 70L illustrated in FIG. 2a is obtained by imaging a subject using the left-eye image capture device 10, and a right-eye image 70R illustrated in FIG. 2b is obtained by imaging a subject using the right-eye image capture device 20.

As shown in FIG. 2a, the left-eye image 70L has an image 71L of the sky in an upper portion and an image 73L of the earth in a lower portion. The approximate central portion of the left-eye image 70L has an image 72L of a house, and there is an image 74L of a person at the lower right.

Similarly, as shown in FIG. 2b, the right-eye image 70R has an image 71R of the sky in an upper portion and an image 73R of the earth in a lower portion. The approximate central portion of the right-eye image 70R has an image 72R of a house, and there is an image 74R of a person at the lower right.

Since the left-eye image capture device 10 and the right-eye image capture device 20 are offset from each other in the horizontal direction, there is parallax between the left-eye image 70L and the right-eye image 70R. For example, the person image 74R in the right-eye image 70R is displaced toward the right side in comparison with the person image 74L in the left-eye image 70L and a portion thereof is missing.

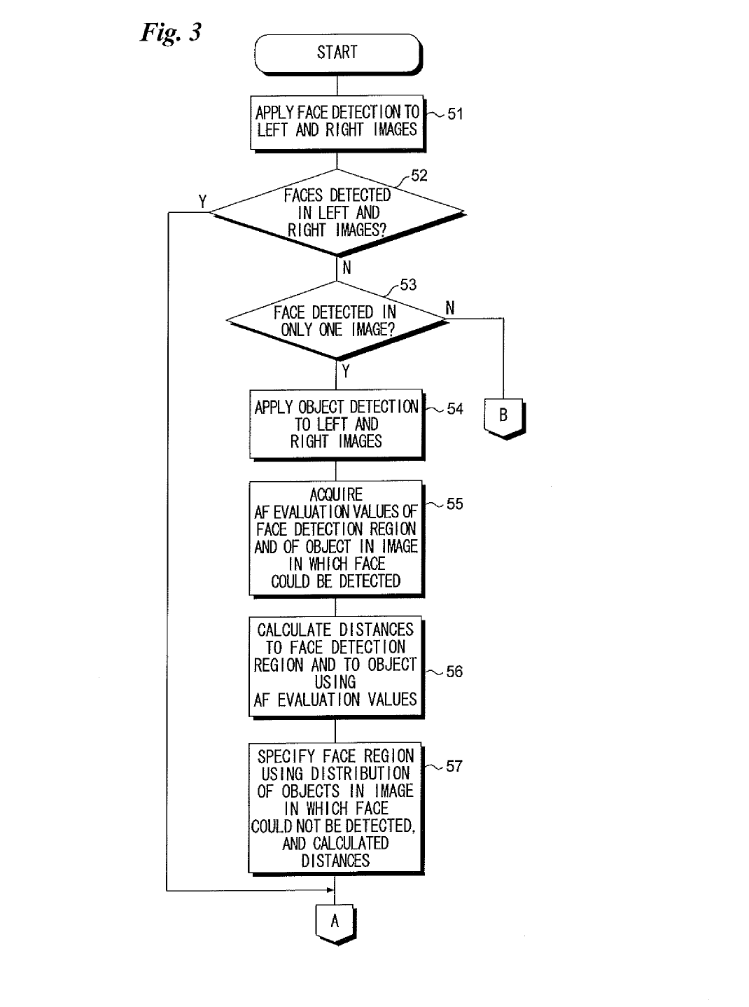

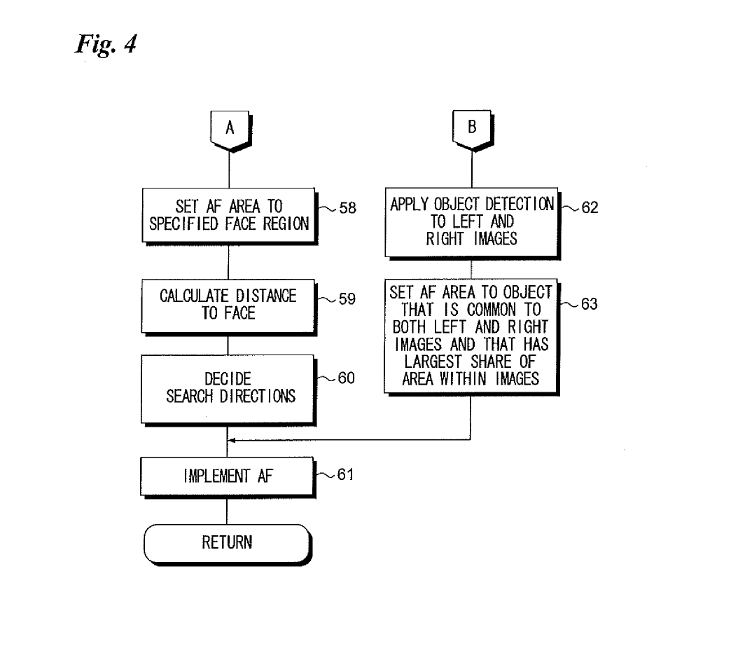

FIGS. 3 and 4 are flowcharts illustrating the processing procedure of the stereoscopic imaging digital camera and mainly show a processing procedure for face image detection.

When the left-eye image 70L and right-eye image 70R are obtained by imaging, face image detection processing is executed in the images of respective ones of the left-eye image 70L and right-eye image 70R (step 51). In processing for face image detection, resize processing is executed in respective ones of the left-eye image 70L and right-eye image 70R in such a manner that the resolution will differ, whereby a plurality of left-eye images and right-eye images are generated. In respective ones of the plurality of left-eye images and right-eye images, regions matching a plurality of face images represented by a plurality of items of face image data that have been stored in advance are detected as face images. If a plurality of face images are extracted, then, in the image having the largest number of detected face images, a region obtained by enlarging or reducing these detected face images to the size that prevailed prior to resizing is adopted as the face image region.

When a face image is not detected in either the left-eye image 70L or the right-eye image 70R (“NO” at step 52), a check is made to determine whether a face image has been detected in only one of the images, namely in only the left-eye image 70L or right-eye image 70R (step 53).

When a face image is detected in only one of the images (“YES” at step 53), object detection processing (object image detection processing) is applied to each of the images, namely to the left-eye image 70L and right-eye image 70R (step 54).

In object detection, an image is divided into a plurality of regions.

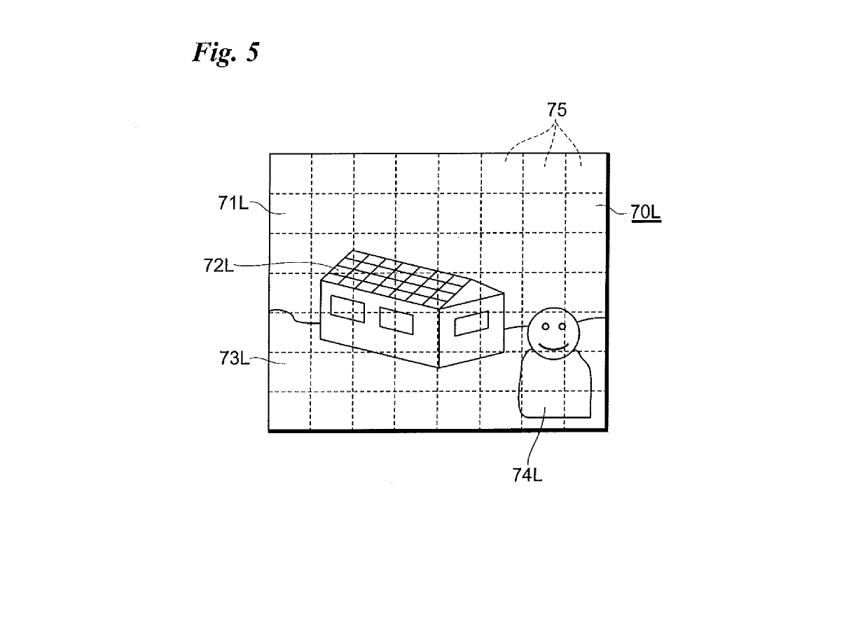

FIG. 5 is an example of the left-eye image 70L, which has been divided into a plurality of regions. The right-eye image 70R also is divided into a plurality of regions.

When the left-eye image 70L is divided into a plurality of regions 75, such features as the photometric values, frequencies and in-image positions of the regions 75 are calculated. The calculated features and the features of objects that have been stored in advance are compared. If a match is achieved, it is decided that the region is an object that has been stored in advance. The same holds true for the right-eye image 70R.

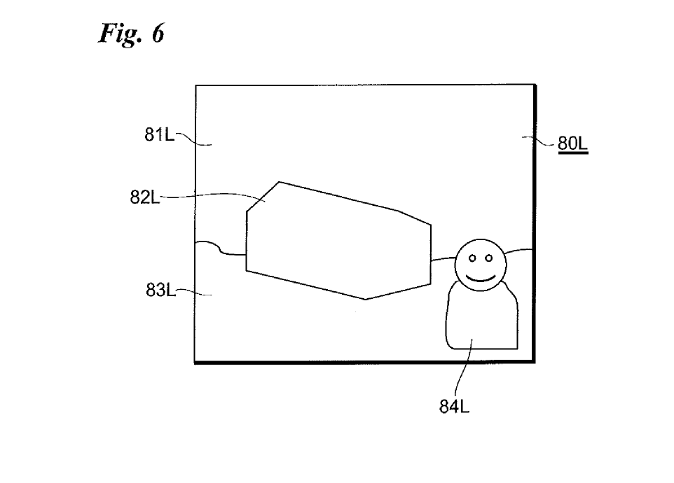

FIG. 6 is an object image indicating the result of object detection in the left-eye image 70L.

Owing to object detection processing, the fact that an image 81L of the sky is in the upper portion of object image 80L and an image 83L of the earth is in a lower portion is detected. Furthermore, the fact that an image 82L of a building is in the central portion of the object image 80L and another image 84L is at the lower right is detected. By executing object detection processing with regard to the right-eye image 70R as well, the images of objects that have been stored in advance are detected.

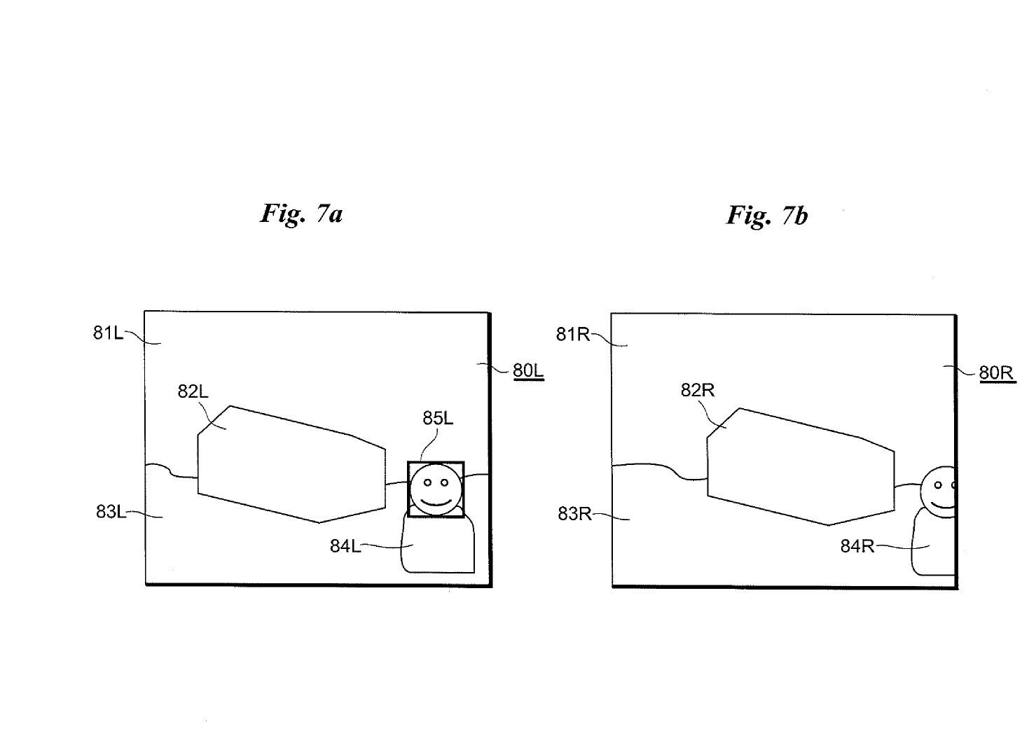

FIG. 7a is the object image 80L of the left-eye image 70L and FIG. 7b an object image 80R of the right-eye image 80R.

In this embodiment, it will be assumed that a face image has been detected from the left-eye image 70L but not from the right-eye image 70R.

With reference to FIG. 7a, the image 81L of the sky, the image 83L of the earth, the image 82L of a building and the other image 84L are detected, as mentioned above. Further, since a face image has been detected from the left-eye image 70L, the portion of the other image 84L that corresponds to the face image is enclosed within a face frame 85L.

With reference to FIG. 7b, an image 81R of the sky, an image 83R of the earth, an image 82R of the building and another image 84R are detected in the upper portion, lower portion, central portion and lower right, respectively, also in the object image 80R of the right-eye image 70R. Since a face image is not detected from the right-eye image 70R, the portion of the other image 84R that corresponds to a face image is not enclosed within a face frame.

With reference again to FIG. 3, AF evaluation values of the images (image 81L of the sky, image 82L of the building, image 83L of the earth and other image 84L) of the detected object regions and the AF evaluation value of the detected face image (the image enclosed within the face frame 85L) are calculated in the object image 80L of the left-eye image 70L in which the face image was detected (step 55). In this embodiment, it will be assumed that the AF evaluation value of the image 82L of the building and the AF evaluation value of the other image 84L are calculated. Similarly, AF evaluation values of the images (image 81R of the sky, image 82R of the building, image 83R of the earth and other image 84R) of the detected object regions are calculated in the object image 80R of the right-eye image 70R in which the face image was not detected (step 55). In this embodiment, it will be assumed that the AF evaluation value of the image 82R of the building and the AF evaluation value of the other image 84R are calculated.

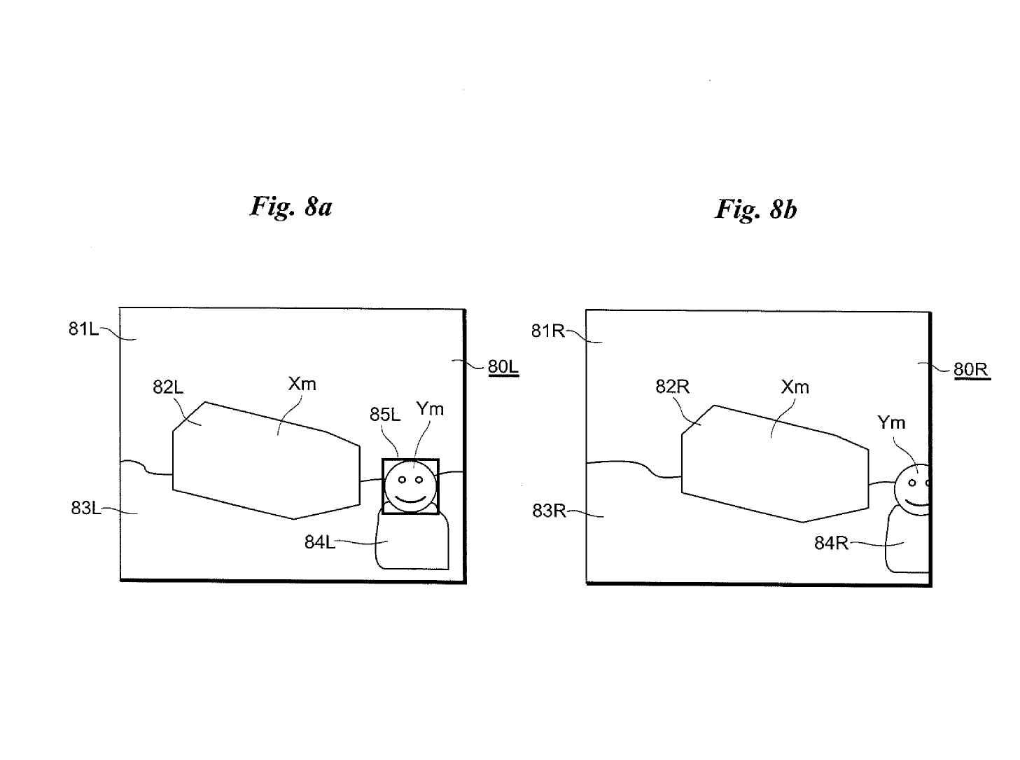

The AF evaluation values are the high-frequency components of image data obtained by image capture while the focusing lens 12 or 22 is moved from a home position. By using the amount of movement (number of driving pulses of the motor driver 15 or 25) from the home position of the focusing lens 12 or 22 that gives the largest AF evaluation value, the distance from the stereoscopic imaging digital camera to an object represented by the image within an object region or to the detected face image is calculated (step 56). For example, assume that the distance to the building represented by the image 82L of the building is Xm and that the distance to the person represented by the other image 84L is Ym, as shown in FIG. 8a, and assume that the distance to the building represented by the image 82R of the building is Xm and that the distance to the person represented by the other image 84R is Ym, as shown in FIG. 8b. When such is the case, it is deemed that the other image 84R, in object image 80R of right-eye image 70R, which is at a distance identical with the distance Ym to the face represented by the face image in object image 80L of left-eye image 70L, includes a face image, and thus a face image is specified from the other image 84R in object image 80R of right-eye image 70R (step 57).

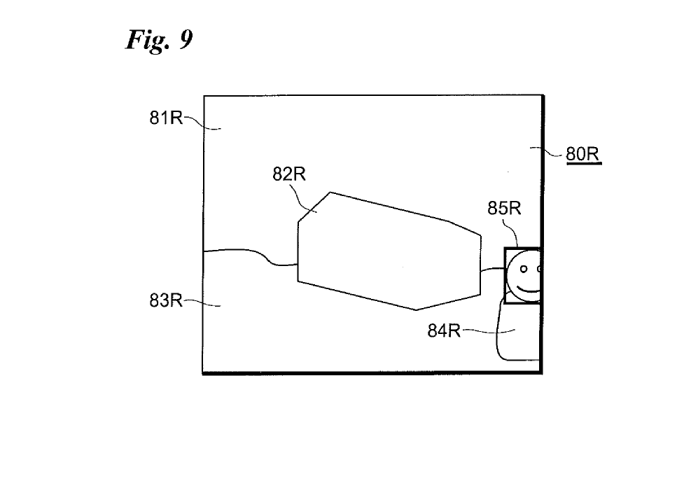

FIG. 9 is the object image 80R of the right-eye image 70R. If a face image is specified, the specified face image is enclosed within a face frame 85R in the manner described above.

Since face images have been specified in both the left-eye image 70L and right-eye image 70R, an AF area is set in such a manner that the face image in the left-eye image 70L and the face image in the right-eye image 70R are each brought into focus (step 58). Also in a case where face images have been detected in both the left-eye image 70L and right-eye image 70R (“YES” at step 52), the face images detected in both images 70L and 70R are set as the AF area (step 58). When this is done, the distance from the stereoscopic imaging digital camera to the face is calculated (step 59).

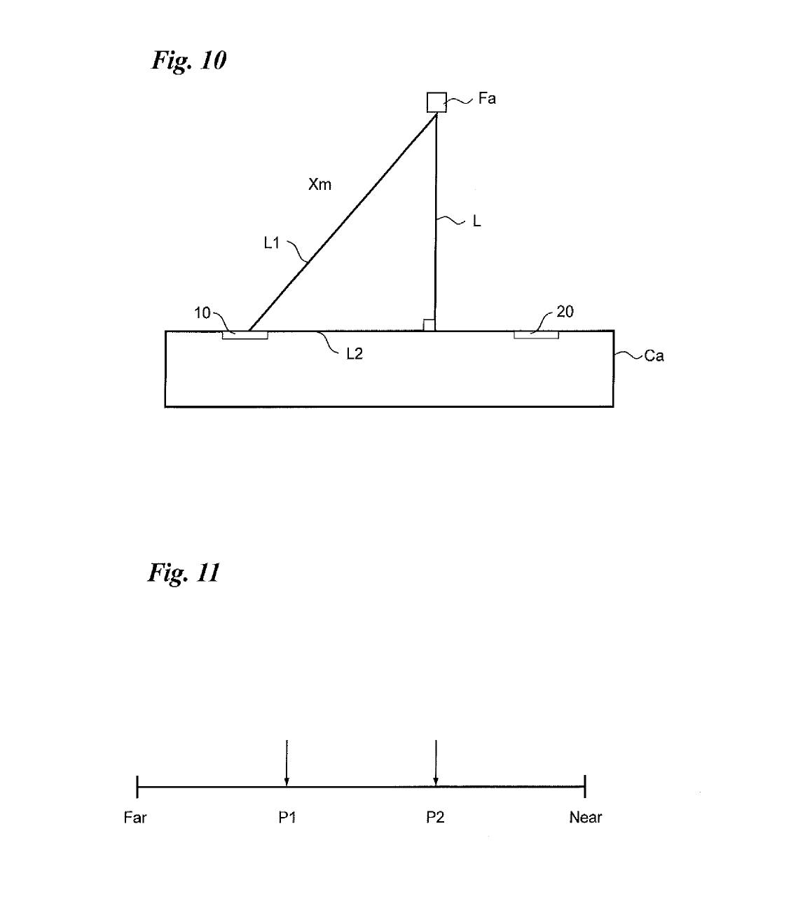

FIG. 10 is for describing how this distance is calculated.

The distance is a length L of a normal dropped perpendicularly on a stereoscopic imaging digital camera Ca from a face Fa. If we assume that the distance from the left-eye image capture device 10 to the face Fa is Xm, as mentioned above, and that the angle defined by a straight line L1 from the left-eye image capture device 10 to the face and a straight line L2 between the left-eye image capture device 10 and right-eye image capture device 20 is θ, then the distance is found by distance L=Xmsinθ. It goes without saying that, since the face image has been detected as set forth above, the angle θ can be calculated by referring to the angle of view (a set value) of the left-eye image capture device 10.

The directions of movement (search directions) of the respective focusing lenses 12 and 22 are decided from the calculated distance to the face and the respective present positions of the focusing lenses 12 and 22 (step 60).

FIG. 11 illustrates the lens position of the focusing lens 12 or 22.

Assume that the present lens position of the focusing lens 12 or 22 is position P1. Since it will be understood from the calculated distance to the face that the lenses 12 and 22 should be moved to position P2 (face-image in-focus position), the focusing lenses 12 and 22 are moved so as to travel from the present position P1 to the position P2.

While the focusing lenses 12 and 22 are moved in the respective directions that have been decided, the focusing lenses 12 and 22 are positioned (AF is executed) at identical positions where the AF evaluation value is maximized (step 61).

If a face image has not been detected in either the left-eye image 70L or the right-eye image 70R (“NO” at step 53), the above-described object detection processing is executed in each of the left- and right-eye images 70L and 70R, respectively (step 62). When this is done, the image of an object that has been detected in common in both of the images 70L and 70R and that occupies the largest share of the images is set as the AF area (step 63). The focusing lenses 12 and 22 are positioned in such a manner that the images within the set AF areas are brought into focus (step 61).

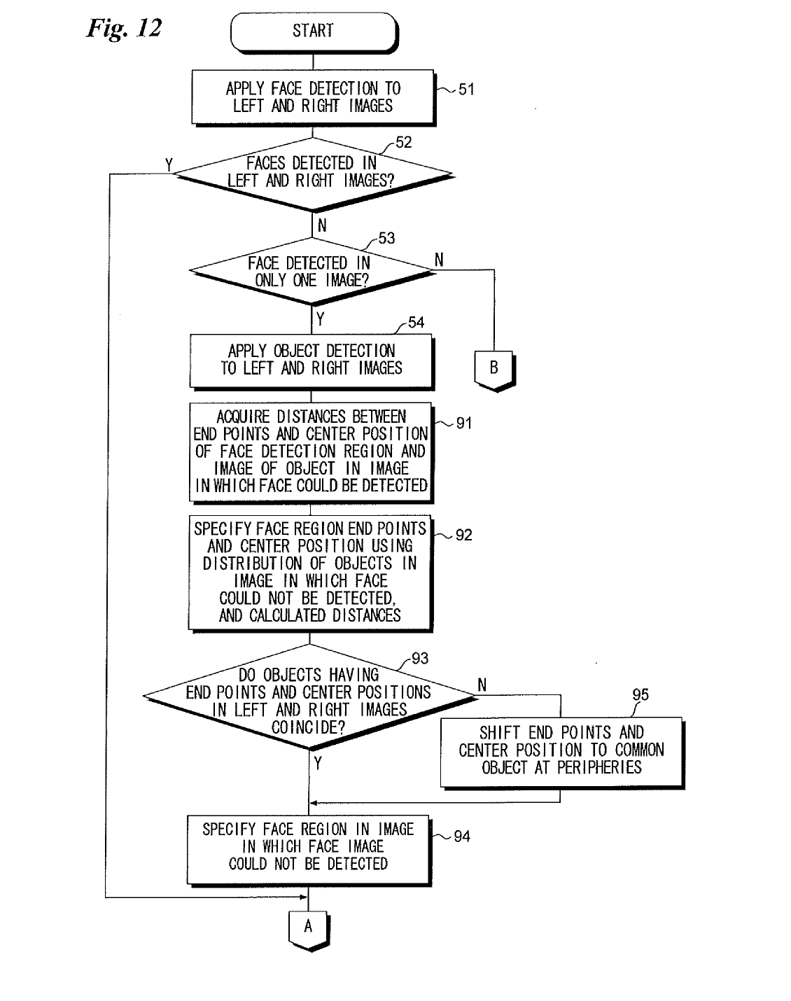

FIGS. 12 to 15 illustrate another embodiment.

FIG. 12, which corresponds to FIG. 3, is part of a flowchart illustrating a processing procedure of the stereoscopic imaging digital camera. Processing steps in FIG. 12 identical with those shown in FIG. 3 are designated by like step numbers and need not be described again. This embodiment utilizes the distance between an image, which represents an object, and a detected face image to thereby specify a face image from an image, which is either a left-eye image or a right-eye image, in which a face image could not be detected.

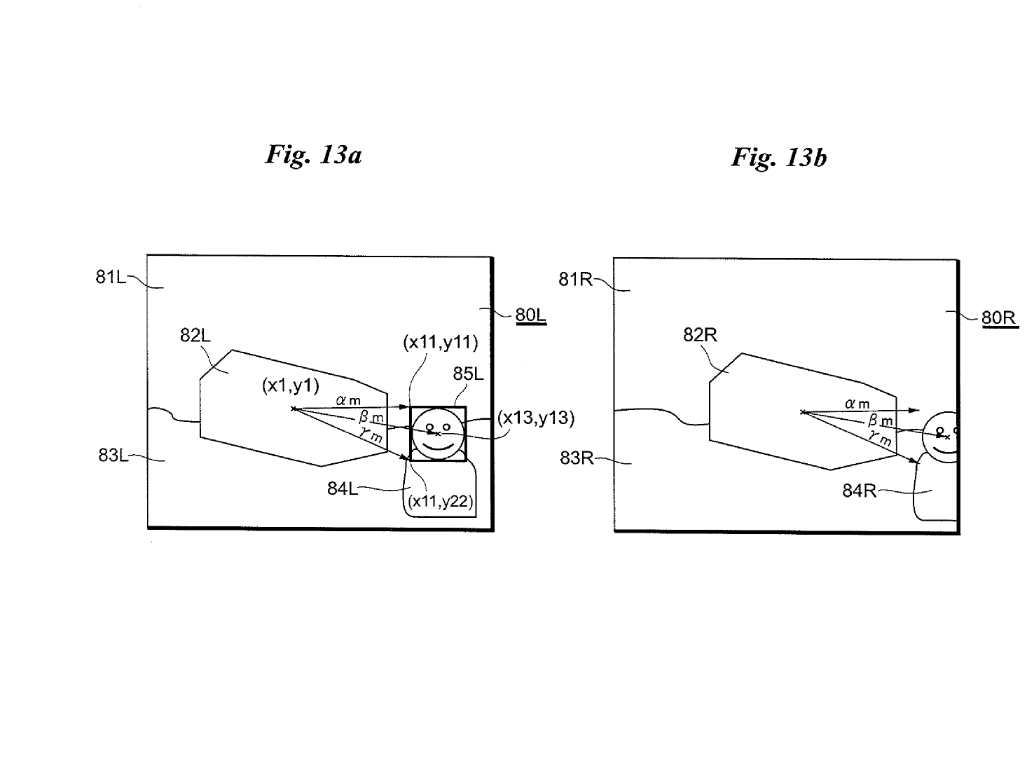

In a manner similar to that described above, assume that a face has been detected only from the left-eye image 70L and not from the right-eye image 70R. Object detection is applied to each of the images, namely to the left-eye image 70L and right-eye image 70R (step 54) and, as illustrated in FIGS. 13a and 13b, the object image 80L of the left-eye image 70L and the object image 80R of the right-eye image 70R are obtained.

In the object image 80L shown in FIG. 13a, the image 81L of the sky, the image 83L of the earth, the image 82L of a building and the other image 84L are detected. In the object image 80L shown in FIG. 13b, the image 81R of the sky, the image 83R of the earth, the image 82R of a building and the other image 84R are detected.

In the object image 80L of the left-eye image 70L in which the face image has been detected, distances from the image of a detected object (a single object image, which is assumed to be the image 82R of the building but which may just as well be another image) to the end points and center point of the face frame 85L specifying the detected face image are calculated (step 91). In this embodiment, distances are calculated from the center (x1,y1) of the image 82R of the building to a position (x11,y11) at the upper left of the face frame 85L, a position (x11,y22) at the lower left of the face frame 85L and a position (x13,y13) at the center of the face frame 85L. It will suffice if distances are calculated from the image 82R of the building (or the image of another object) to any two points on the face frame 85R. Let the distances from the center (x1,y1) of the image 82R of the building to the position (x11,y11) at the upper left of the face frame 85L, the position (x11,y22) at the lower left of the face frame 85L and the position (x13,y13) at the center of the face frame 85L be αm, βm and γm, respectively.

The end points and center point of a face image are specified in the right-eye image 70R, in which a face image was not detected, using a distribution (object distribution) of the object images detected in the right-eye image 70R and the distances calculated as described above (step 92). If, as shown in FIG. 13b, the image of an object having the face-image end points and center point specified in the right-eye image 70R coincides with the image of the object having the face-image ends points and center point decided in the left-eye image 70L (“YES” at step 93), then the image of the object having the face-image end points and center point specified in the right-eye image 70R is specified as a face image (step 94). The specified face image is enclosed within the face frame 85R in the manner shown in FIG. 9.

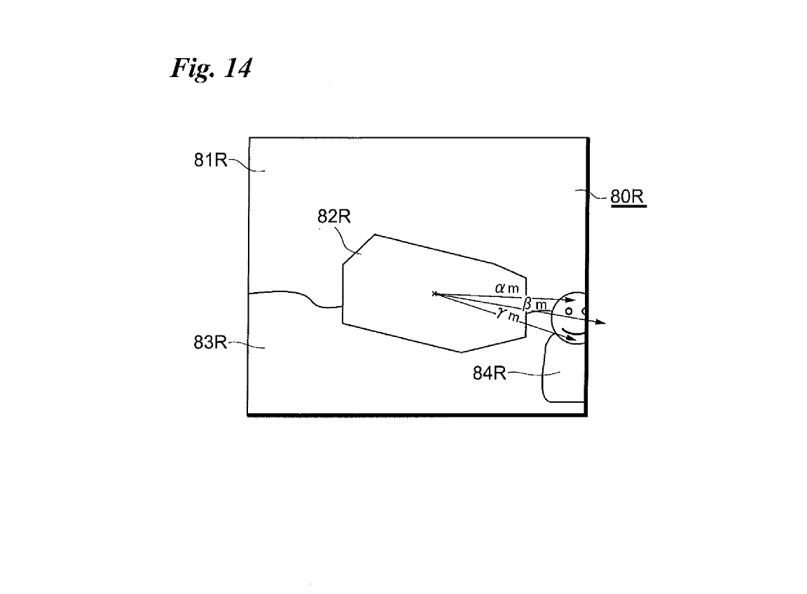

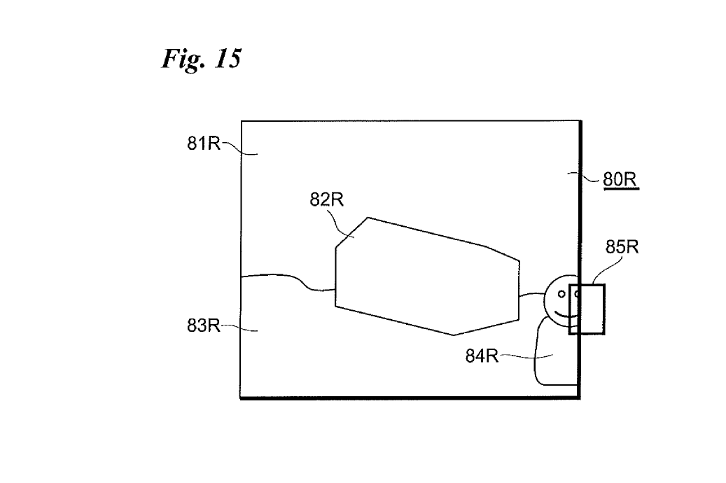

If, as shown in FIGS. 14 and 15, the image of an object having the face-image end points and center point specified in the right-eye image 70R does not coincide with the image of the object having the face-image end points and center point decided in the left-eye image 70L (“NO” at step 93), then the face frame 85R displayed at the calculated distances is shifted to the image of an object that is in the vicinity of the calculated distances and that co-exists in both the object image 80L of the left-eye image 70L and the object image 80R of the right-eye image 70R (step 95) and the face image is specified (step 94). The specified face image is enclosed within the face frame 85R in the manner shown in FIG. 9.

Subsequent processing is similar to the processing shown in FIG. 4.

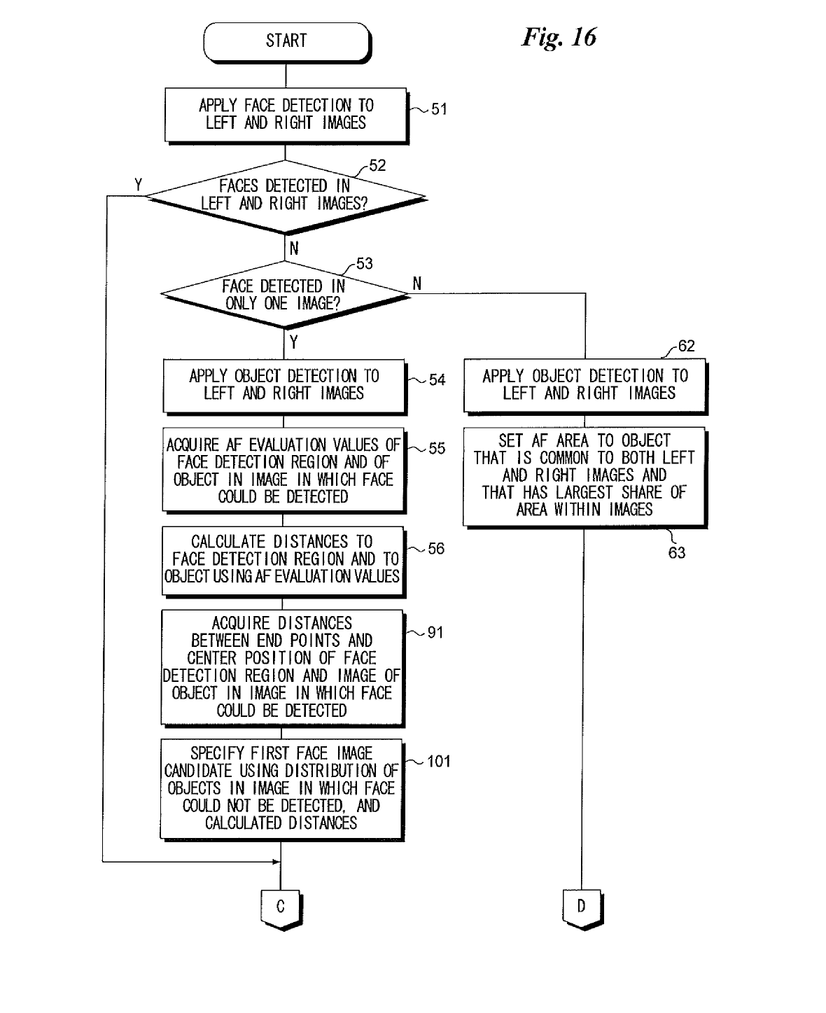

FIGS. 16 to 18 illustrate a further embodiment. This embodiment can be considered to be a combination of the two embodiments described above.

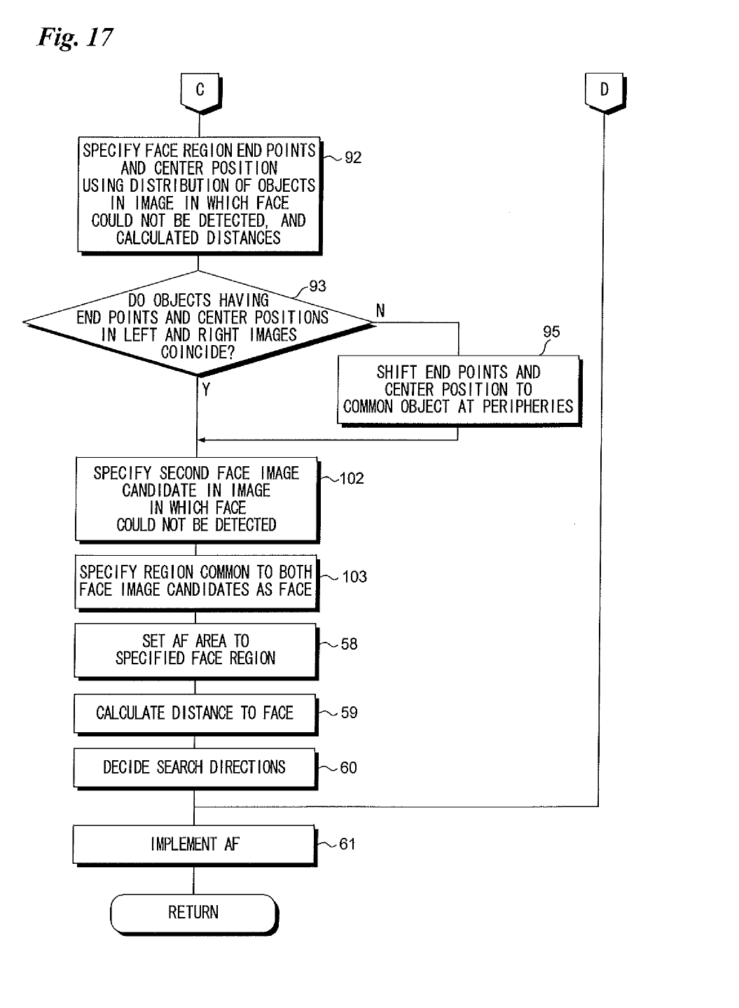

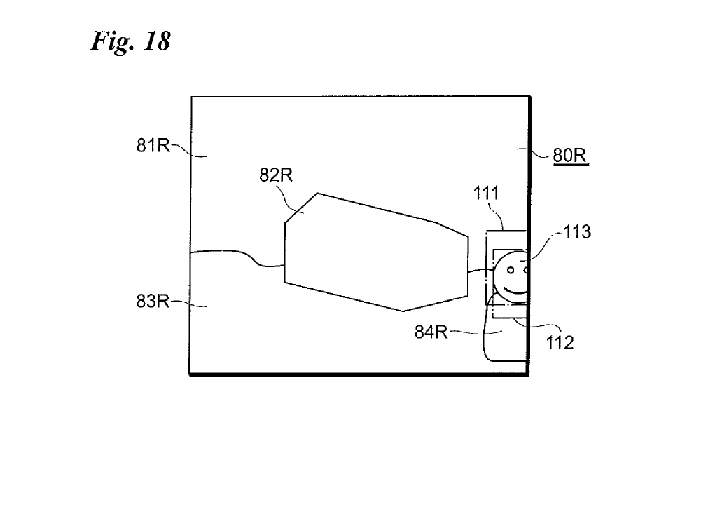

FIGS. 16 and 17 are flowcharts illustrating the processing procedure of the stereoscopic imaging digital camera. Processing steps in these figures identical with those shown in FIGS. 3, 4 or in FIG. 12 are designated by like step numbers and need not be described again. FIG. 18 is the object image 80R of the object image 80R.

It is assumed in this embodiment as well that a face image has been detected in the left-eye image 70L but not in the right-eye image 70R.

As described with reference to FIGS. 3 and 4, object detection is carried out and the distance Xm from the stereoscopic imaging digital camera to the building represented by the image 82L of the building and the distance Ym from the stereoscopic imaging digital camera to the face represented by the detected face image are calculated in the object image 80L of the left-eye image 70L (step 56).

Next, as described with reference to FIG. 12, the distances αm, βm and γm from the image 82L of the building to the end points and center point of the face frame 85L are calculated (step 91).

A first face image candidate region 111 in the right-eye image 70R (object image 80R) is specified (step 101) based upon the distance Xm from the stereoscopic imaging digital camera to the building represented by the image 82L of the building and the distance Ym from the stereoscopic imaging digital camera to the face represented by the detected face image, as mentioned above (see FIG. 18). Furthermore, a second face image candidate region 112 in the right-eye image 70R (object image 80R) is specified (step 102) based upon the distances αm, βm and γm from the image 82L of the building to the end points and center point of the face frame 85L (see FIG. 18).

A region 113 common to both the first face image candidate region 111 and the second face image candidate region 112 thus obtained is specified as a face image (step 103). Subsequent processing is similar to that described above.

In the foregoing embodiments, face images are detected and specified utilizing the left-eye image obtained by imaging in the left-eye image capture device 10 and the right-eye image obtained by imaging in the right-eye image capture device 20. However, it may be arranged so that face images are detected and specified utilizing left- and right-eye images represented respectively by left- and right-eye image data that has been recorded on the memory card 42.

1. A stereoscopic imaging apparatus comprising:
a left-eye image capture device for capturing a left-eye image constituting a stereoscopic image;
a right-eye image capture device for capturing a right-eye image constituting the stereoscopic image;
a face image detection device for detecting face images in respective ones of the left-eye image captured in said left-eye image capture device and right-eye image captured in said right-eye image capture device;
an object image detection device for detecting, in accordance with detection of a face image from only one image of said left-eye image and said right-eye image in said face image detection device, object images contained in the other image of said left-eye image and said right-eye image in which a face image was not detected by said face image detection device;
a first distance calculation device for calculating distance from the stereoscopic imaging apparatus to the face represented by the face image detected by said face image detection device; and
a face image decision device for deciding that, from among the object images detected by said object image detection device, an object image representing an object having the distance calculated by said first distance calculation device is a face image in said other image.

2. A stereoscopic imaging apparatus according to claim 1, further comprising:
a left-eye focusing lens provided in front of a solid-state electronic image sensing device, which is included in said left-eye image capture device, and freely movable along the direction of an optic axis of said left-eye image capture device;
a right-eye focusing lens provided in front of a solid-state electronic image sensing device, which is included in said right-eye image capture device, and freely movable along the direction of an optic axis of said right-eye image capture device;
a second distance calculation device for calculating distance from the stereoscopic imaging apparatus to the face represented by the face image decided by said face image decision device; and
a focus control device for deciding directions of movement of respective ones of said left-eye focusing lens and said right-eye focusing lens based upon the distance calculated by said second distance calculation device and positions of respective ones of said left-eye focusing lens and said right-eye focusing lens, and controlling focusing while moving said left-eye focusing lens and said right-eye focusing lens along the directions decided.

3. A stereoscopic imaging apparatus comprising:
a left-eye image capture device for capturing a left-eye image constituting a stereoscopic image;
a right-eye image capture device for capturing a right-eye image constituting the stereoscopic image;
a face image detection device for detecting face images in respective ones of the left-eye image captured in said left-eye image capture device and right-eye image captured in said right-eye image capture device;
an object image detection device for detecting, in accordance with detection of a face image from only one image of said left-eye image and said right-eye image in said face image detection device, object images contained in respective ones of said left-eye image and said right-eye image;
a first distance calculation device for calculating distance from the stereoscopic imaging apparatus to the face represented by the face image detected by said face image detection device;
a first face image candidate region decision device for deciding that, from among the object images, which were detected by said object image detection device, contained in said other image of said left-eye image and said right-eye image in which a face image was not detected by said face image detection device, an object image representing an object having the distance calculated by said first distance calculation device is a first face image candidate region in said other image;
a distance calculation device for calculating, in said one image, distances from one object image among the object images detected by said object image detection device to at least two points that specify the face image;
a second face image candidate region decision device for deciding that, in said other image, an object represented by an object image at the distances, calculated by said distance calculation device, from another object image, which corresponds to said one object image from among the object images detected by said object image detection device, to the at least two points is a second face image candidate region in said other image based upon coincidence with an object represented by an object image at the distances from said one object image to the at least two points; and
a face image decision device for deciding that a region common to both the first face image candidate region decided by said first face image candidate region decision device and the second face image candidate region decided by said second face image candidate region decision device is a region of a face image in said other image.

4. A stereoscopic imaging apparatus according to claim 3, further comprising:
a left-eye focusing lens provided in front of said left-eye image capture device and freely movable along the direction of an optic axis of said left-eye image capture device;
a right-eye focusing lens provided in front of said right-eye image capture device and freely movable along the direction of an optic axis of said right-eye image capture device;
a second distance calculation device for calculating distance from the stereoscopic imaging apparatus to the face represented by the region of the face image decided by said face image decision device; and
a focus control device for deciding directions of movement of respective ones of said left-eye focusing lens and said right-eye focusing lens based upon the distance calculated by said second distance calculation device and positions of respective ones of said left-eye focusing lens and said right-eye focusing lens, and controlling focusing while moving said left-eye focusing lens and said right-eye focusing lens along the directions decided.

5. A face detection apparatus comprising:
a face image detection device for detecting face images in respective ones of a left-eye image and a right-eye image constituting a stereoscopic image;
an object image detection device for detecting, in accordance with detection of a face image from only one image of said left-eye image and said right-eye image in said face image detection device, object images contained in respective ones of said left-eye image and said right-eye image;
a distance calculation device for calculating, in said one image, distances from one object image among the object images detected by said object image detection device to at least two points that specify the face image; and
a face image decision device for deciding that, in said other image, an object represented by an object image at the distances, calculated by said distance calculation device, from another object image, which corresponds to said one object image from among the object images detected by said object image detection device, to the at least two points is a face image in said other image based upon coincidence with an object represented by an object image at the distances from said one object image to the at least two points.

6. A face detection apparatus according to claim 5, wherein said face image decision device decides that, in said other image, an object image in the vicinity of the distances from said one object image to the at least two points is a face image in said other image based upon non-coincidence of an object, which is represented by an object image at the distances, calculated by said distance calculation device, from another object image, which corresponds to said one object image from among the object images detected by said object image detection device, to the at least two points, with an object represented by an object image at the distances from said one object image to the at least two points.

7. A face detection apparatus according to claim 6, further comprising:
a left-eye image capture device for capturing a left-eye image constituting a stereoscopic image; and
a right-eye image capture device for capturing a right-eye image constituting the stereoscopic image;
said face image detection device detecting face images in respective ones of said left-eye image and said right-eye image captured in respective ones of said left-eye image capture device and said right-eye image capture device;
a left-eye focusing lens provided in front of said left-eye image capture device and freely movable along the direction of an optic axis of said left-eye image capture device;
a right-eye focusing lens provided in front of said right-eye image capture device and freely movable along the direction of an optic axis of said right-eye image capture device;
a second distance calculation device for calculating distance from the face detection apparatus to the face represented by the face image decided by said face image decision device; and
a focus control device for deciding directions of movement of respective ones of said left-eye focusing lens and said right-eye focusing lens based upon the distance calculated by said second distance calculation device and positions of respective ones of said left-eye focusing lens and said right-eye focusing lens, and controlling focusing while moving said left-eye focusing lens and said right-eye focusing lens along the directions decided.

8. A method of controlling operation of a stereoscopic imaging apparatus, comprising:
a left-eye image capture device capturing a left-eye image constituting a stereoscopic image;
a right-eye image capture device capturing a right-eye image constituting the stereoscopic image;
a face image detection device detecting face images in respective ones of the left-eye image captured in said left-eye image capture device and right-eye image captured in said right-eye image capture device;
an object image detection device detecting, in accordance with detection of a face image from only one image of said left-eye image and said right-eye image in said face image detection device, object images contained in the other image of said left-eye image and said right-eye image in which a face image was not detected by said face image detection device;
a distance calculation device calculating distance from the stereoscopic imaging apparatus to the face represented by the face image detected by said face image detection device; and
a face image decision device deciding that, from among the object images detected by said object image detection device, an object image representing an object having the distance calculated by said first distance calculation device is a face image in said other image.

9. A method of controlling operation of a stereoscopic imaging apparatus, comprising:
a left-eye image capture device capturing a left-eye image constituting a stereoscopic image;
a right-eye image capture device capturing a right-eye image constituting the stereoscopic image;
a face image detection device detecting face images in respective ones of the left-eye image captured in said left-eye image capture device and right-eye image captured in said right-eye image capture device;
an object image detection device detecting, in accordance with detection of a face image from only one image of said left-eye image and said right-eye image in said face image detection device, object images contained in respective ones of said left-eye image and said right-eye image;
a first distance calculation device calculating distance from the stereoscopic imaging apparatus to the face represented by the face image detected by said face image detection device;
a first face image candidate region decision device deciding that, from among the object images, which were detected by said object image detection device, contained in said other image of said left-eye image and said right-eye image in which a face image was not detected by said face image detection device, an object image representing an object having the distance calculated by said first distance calculation device is a first face image candidate region in said other image;
a second distance calculation device calculating, in said one image, distances from one object image among the object images detected by said object image detection device to at least two points that specify the face image;
a second face image candidate region decision device deciding that, in said other image, an object represented by an object image at the distances, calculated by said distance calculation device, from another object image, which corresponds to said one object image from among the object images detected by said object image detection device, to the at least two points is a second face image candidate region in said other image based upon coincidence with an object represented by an object image at the distances from said one object image to the at least two points; and
a face image decision device deciding that a region common to both the first face image candidate region decided by said first face image candidate region decision device and the second face image candidate region decided by said second face image candidate region decision device is a region of a face image in said other image.

10. A method of controlling operation of a face detection apparatus, comprising:
a face image detection device detecting face images in respective ones of a left-eye image and a right-eye image constituting a stereoscopic image;
an object image detection device detecting, in accordance with detection of a face image from only one image of said left-eye image and said right-eye image in said face image detection device, object images contained in respective ones of said left-eye image and said right-eye image;
a distance calculation device calculating, in said one image, distances from one object image among the object images detected by said object image detection device to at least two points that specify the face image; and
a face image decision device deciding that, in said other image, an object represented by an object image at the distances, calculated by said distance calculation device, from another object image, which corresponds to said one object image from among the object images detected by said object image detection device, to the at least two points is a face image in said other image based upon coincidence with an object represented by an object image at the distances from said one object image to the at least two points.
